(19) United States
(12) Patent Application Publication
(10) Pub. No.: US 2004/0170275 A1
(43) Pub. Date: Sep. 2, 2004

(54) Apparatus and method for cryptographing and deciphering image

(76) Inventors: Sang Su Lee, Daegu-city (KR); Jong Wook Han, Daejeon-city (KR); Sung Won Sohn, Daejeon-city (KR); Chee Hang Park, Daejeon-city (KR); Jong Yun Kim, Kangwon-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/646,589

(22) Filed: Aug. 21, 2003

(30) Foreign Application Priority Data
Feb. 27, 2003 (KR) 2003-12352

(51) Int. Cl. G09C 3/00

(52) U.S. Cl. 380/54

(57) ABSTRACT

Provided are an apparatus and method for cryptographing and/or deciphering an image. The apparatus includes an image segmenting unit, a random image generating unit, a cryptographing unit, and a phase card generating unit. The image segmenting unit segments an input binary image into images. The random image generating unit generates as many random images as the segmented images. The cryptographing unit performs XOR operations on the segmented images and the random images on a one-to-one basis to produce as many cryptographed images as the segmented images. The phase card generating unit assigns phase values of π and 0 to black and white pixels of the cryptographed images to generate phase cards corresponding to the cryptographed images.

### BACKGROUND OF THE INVENTION

This application claims the priority of Korean Patent Application No. 2003-12352, filed on Feb. 27, 2003, in the Korean Intellectual Property Office, the disclosure of which is incorporated herein in its entirety by reference.

1. Field of the Invention

The present invention relates to an apparatus and method for cryptographing and/or deciphering an image, and more particularly, to an apparatus and method for cryptographing and/or deciphering a binary image by segmenting the binary image into a desired number of images.

2. Description of the Related Art

A variety of security systems are used to prevent illegal accesses to secret information. In particular, information security systems have been continuous concerns in military sectors or specific research sectors. Since most of security systems adopt a digital way, they can protect data itself using a cryptographic method. However, it is easy for an attacker to copy cryptographed information. In addition, an intelligent attacker may analogize an access to security systems from cryptographed information. A cryptographic method using digital equipment, which is currently adopted in various fields, provides good cipher strength, while allowing an attacker to easily copy cryptographed information. Thus, the cryptographic method may expose the security systems to easily cryptographic accesses.

When cryptographed information is converted into phase information and then recorded on a medium such as a transparent glass plate, the phase information cannot be easily deciphered from the medium. In particular, the phase information recorded on the medium cannot be deciphered through the human visual system or equipment such as a camera and a charged coupled device (CCD) responding to the strength of light. Thus, information can be protected through the conversion of the cryptographed information into the phase information. An optical cryptographic method using a phase contrast effect is an example of protecting information.

When information is cryptographed using the optical cryptographic method, for example, a method of converting information into phase information corresponding to a phase of light using a hologram or a phase mask and then recording the phase information on a medium, the distribution of the recorded information cannot be sensed through the human visual system, a camera, a CCD, or the like. Therefore, the optical cryptographic method contributes to a stronger protection of information. This information protecting method includes an image deciphering method using a phase contrast effect and a phase hologram method. However, this information protecting method is used for only recording and reproduction of a cryptographed image.

### SUMMARY OF THE INVENTION

The present invention provides an apparatus and method for cryptographing an image so as to protect the image against a cryptanalysis.

The present invention also provides an apparatus and method for deciphering a cryptographed image so as to protect the cryptographed image against a cryptanalysis.

According to an aspect of the present invention, there is provided an apparatus for cryptographing an image. The apparatus includes an image segmenting unit, a random image generating unit, a cryptographing unit, and a phase card generating unit. The image segmenting unit segments an input binary image into images. The random image generating unit generates as many random images as the segmented images. The cryptographing unit performs XOR operations on the segmented images and the random images on a one-to-one basis to produce as many cryptographed images as the segmented images. The phase card generating unit assigns phase values of π and 0 to black and white pixels of the cryptographed images to generate phase cards corresponding to the cryptographed images.

According to another aspect of the present invention, there is provided a method of cryptographing an image. An input binary image is segmented into images. As many random images as the segmented images are generated. XOR operations are performed on the segmented images and the random images on a one-to-one basis to produce as many cryptographed images as the segmented images. Phase values of π and 0 are assigned to black and white pixels of the cryptographed images to generate phase cards corresponding to the cryptographed images.

According to still another aspect of the present invention, there is provided an apparatus for deciphering an image. The apparatus includes a light source, a polarized beam splitter, a first mirror, a second mirror, a beam splitter, and a polarizer. The light source outputs a linearly polarized beam with a short wavelength. The polarized beam splitter splits the linearly polarized beam into two linearly polarized orthogonal beams. The first mirror reflects a vertically polarized beam emitted from the polarized beam splitter through a first optical path. The second mirror reflects a horizontally polarized beam emitted from the polarized beam splitter through a second optical path. The beam splitter combines the vertically and horizontally polarized beams reflected from the first and second mirrors into a beam with a new polarization orientation. The polarizer transmits only a one-orientation-polarized beam of the combined beam so as to decipher the image. Here, phase cards are generated by assigning phase values of π and 0 to black and white pixels of cryptographed images so as to be respectively located in optical paths between the first mirror and the beam splitter and between the polarized beam splitter and the second mirror.

According to yet another aspect of the present invention, there is provided a method of deciphering an image. A linearly polarized beam with a short wavelength emitted from a light source splitting is split into two linearly polarized orthogonal beams. The two linearly polarized orthogonal beams are transmitted through phase cards that are generated by assigning phase values of π and 0 to black and white pixels of cryptographed images and located in optical paths through which the two linearly polarized orthogonal beams pass. The two linearly polarized orthogonal beams, which have passed through the phase cards, are combined into one polarized beam with a new polarization orientation. Only a one-orientation-polarized beam of the combined polarized beam is transmitted so as to decipher the image.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an image cryptographing apparatus according to the present invention;

FIG. 2 is a flowchart of a method of cryptographing a binary image;

FIG. 3 is a view for explaining a method of generating random binary images necessary for cryptography;

FIG. 4 is a view showing the results of exclusive OR (XOR) operations performed on black and white pixels;

FIG. 5 shows the thickness of a phase card varying depending on a pixel value and a phase of light shifting after transmitting through the phase card;

FIG. 6 is a view showing the results of XOR operations performed on three images into which a binary image is segmented;

FIG. 7 is a flowchart of a method of cryptographing an image according to the present invention;

FIG. 8 is a block diagram of an image deciphering system according to the present invention;

FIGS. 9A and 9B are views showing variations in phases of two linearly polarized beams and polarization orientations a beam into which the two linearly polarized beams are combined;

FIG. 10 is a flowchart of a method of deciphering an image according to the present invention;

FIGS. 11A and 11B are views showing images and phase cards produced when cryptographing an image using the image cryptographing method of the present invention;

FIG. 12 is a view showing vibration orientations of two linearly polarized beams transmitting through phase cards in the image deciphering apparatus of the present invention and phase orientations of a polarized beam into which the two linearly polarized beams are combined; and

FIG. 13 is a view showing an image deciphered through an experiment.

### DETAILED DESCRIPTION OF THE INVENTION

Hereinafter, an apparatus and method for cryptographing and/or deciphering an image according to the present invention will be described in detail with reference to the attached drawings.

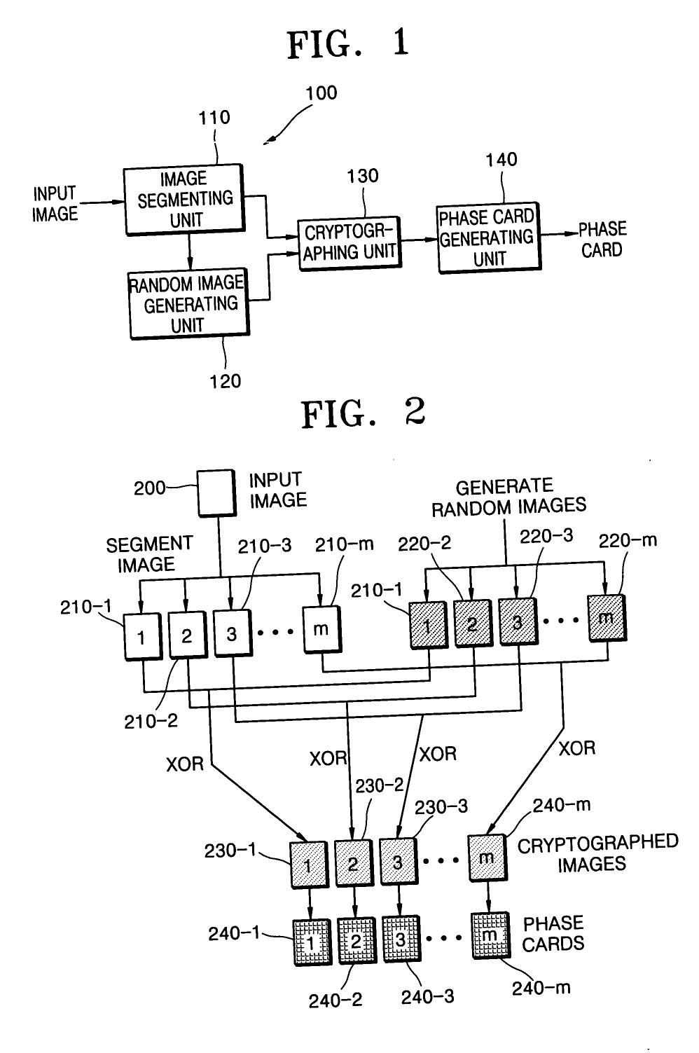

FIG. 1 is a block diagram of an image cryptographing apparatus according to the present invention, and FIG. 2 is a flowchart of a method of cryptographing a binary image. Referring to FIGS. 1 and 2, an image cryptographing apparatus 100 includes an image segmenting unit 110, a random image generating unit 120, a cryptographing unit 130, and a phase card generating unit 140.

The image segmenting unit 110 segments an input binary image 200 into a predetermined number, for example, m, of images. Here, the image segmenting unit 110 may segment the input binary image 200 into a predetermined number of images or a predetermined size of images. If the image segmenting unit 110 is set so as to segment the input binary image 200 into m images, the image segmenting unit 110 outputs m segmented images 210-1 through 210-m.

The random image generating unit 120 generates as many random binary images 220-1 through 220-m as the m segmented images 210-1 through 210-m. Here, the random image generating unit 120 receives information on the number of m segmented images 210-1 through 210-m from the image segmenting unit 110. Alternatively, the random image generating unit 120 may detect the number of m segmented images 210-1 through 210-m from a predetermined segmentation number or size.

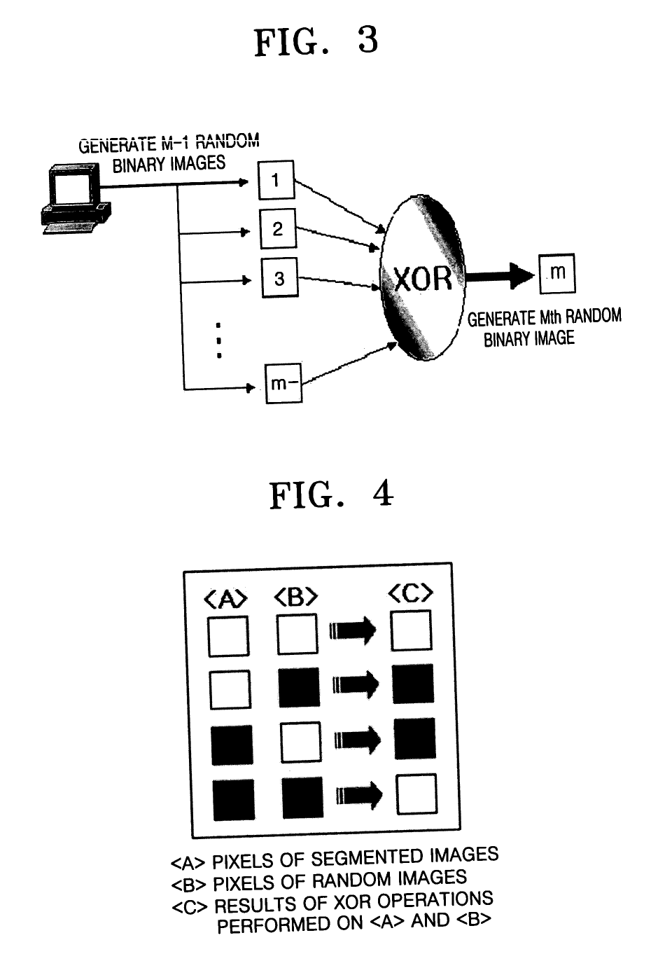

FIG. 3 is a view for explaining a method of generating random binary images necessary for cryptograph. As shown in FIG. 3, when an original image is segmented into m images, the random image generating unit 120 generates m−1 different random binary images and performs XOR operations on the m−1 different random binary images to produce another random binary image. Here, as shown in FIG. 4, the XOR operations are performed on pixels of segmented images and pixels of random images corresponding to the pixels of the segmented images.

The cryptographing unit 130 performs XOR operations on the segmented images 210-1 through 210-m and the random binary images 220-1 through 220-m on a one-to-one basis to generate cryptographed binary images 230-1 through 230-m.

The phase card generating unit 140 generates phase cards 240-1 through 240-m by assigning phase values of rr and 0 to black and white pixels of the cryptographed binary image pixels 230-1 through 230-m. The phase card generating unit 140 increases the thickness of a transparent medium such as indium-tin-oxide (ITO) glass by etching the transparent medium with a Buffered Hydro-Fluoric (BHF) solution. Here, the black and white pixels of the cryptographed binary image pixels 230-1 through 230-m correspond to phase values of π and 0 on the phase cards. Such phase values vary the thickness of the transparent medium, which can be calculated from Equation 1:

$$D = \frac{λφ}{2 π ( n - 1 )} \qquad ( 1 )$$

wherein λ denotes a wavelength of light transmitting through a phase card, φ denotes a phase value to be expressed, and n denotes a refractive index of a medium of which the phase card is made.

When a pixel value of a phase card is 0, φ may be set to a random even number. When the pixel value of the phase card is π, φ may be set to a random odd number. As a result, a phase difference of π occurs. Accordingly, when light transmits through a phase card with a thickness distribution corresponding to a phase distribution, a phase of the light is delayed by a phase value of the phase card.

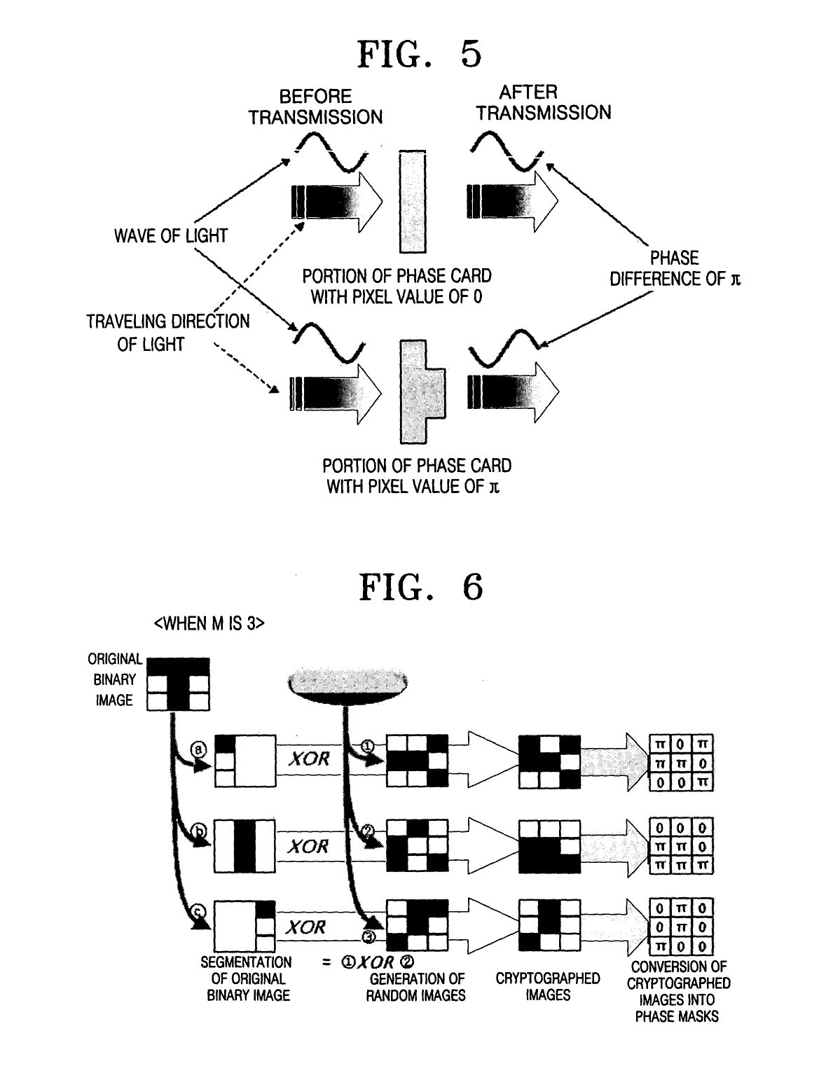

FIG. 5 shows the thickness of a phase card varying depending on a pixel value and a phase of light shifting after transmitting through the phase card. As can be seen in FIG. 5, light shows a phase difference of π after passing through a portion of a phase card with a pixel value of 0 and a portion of the phase card with a pixel value of rr.

FIG. 6 shows an aspect of a process of cryptographing three images into which an input binary image is segmented. Referring to FIG. 6, when a number of segmented images is set to m (where m is 3), an input binary image is vertically segmented into three images. Next, XOR operations are performed on the three images and three random images generated by a random number generator to produce cryptographed images and convert the cryptographed images into three phase cards. Here, areas of the phase cards with images have phase values of π and areas of the phase cards with no image have phase values of 0.

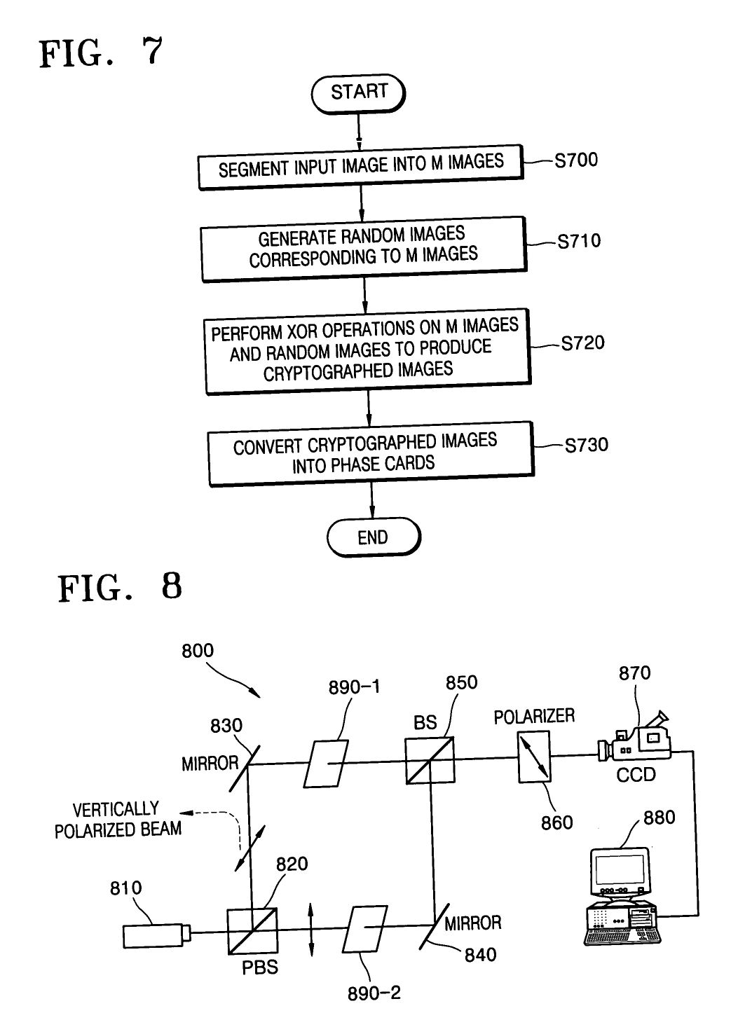

FIG. 7 is a flowchart of a method of cryptographing an image according to the present invention. Referring to FIG. 7, in step S700, the image segmenting unit 110 segments an input binary image into m images. In step S710, the random image generating unit 120 generates random images corresponding to the m images. In step S720, the cryptographing unit 130 performs XOR operations on the m images and the random images to generate cryptographed images. In step S730, the phase card generating unit 140 generates phase cards which express the cryptographed images with phase values of π and 0.

FIG. 8 is a block diagram of an image deciphering apparatus according to the present invention. Referring to FIG. 8, an image deciphering apparatus 800 includes a light source 810, a polarized beam splitter (PBS) 820, a first mirror 830, a second mirror 840, a beam splitter (BS) 850, and a polarizer 860.

The light source 810 emits a linearly polarized beam with a short wavelength. The light source 810 may be a laser generator. The PBS 820 splits the linearly polarized beam emitted from the light source 810 into two linearly polarized orthogonal beams. The two linearly polarized orthogonal beams proceed through different optical paths according to polarization orientations. The first mirror 830 reflects the vertically polarized beam toward the BS 850 while the second mirror 840 reflects the horizontally polarized beam toward the BS 850. The BS 850 couples the vertically and horizontally polarized beams to output a coupled beam with a new polarization orientation. The polarizer 860 transmits only a one-orientation-polarized beam of the coupled beam. The polarizer 860 projects the one-orientation-polarized beam onto a CCD 870 so as to decipher an image. The CCD 870 outputs the deciphered image to an image display device 880. The PBS 820, the first mirror 830, the second mirror 840, and the BS 850 constitute a Mache-Gender interferometer.

Phase cards 890-1 and 890-2 generated by the image cryptographing apparatus 100 are respectively located between the first mirror 830 and the BS 850 and between the PBS 820 and the second mirror 840. Phases of two beams passing through the phase cards 890-1 and 890-2 are delayed depending on the thickness of the phase cards 890-1 and 890-2. The two beams are combined into one by the BS 850 located at an output point of the Mache-Gender interferometer.

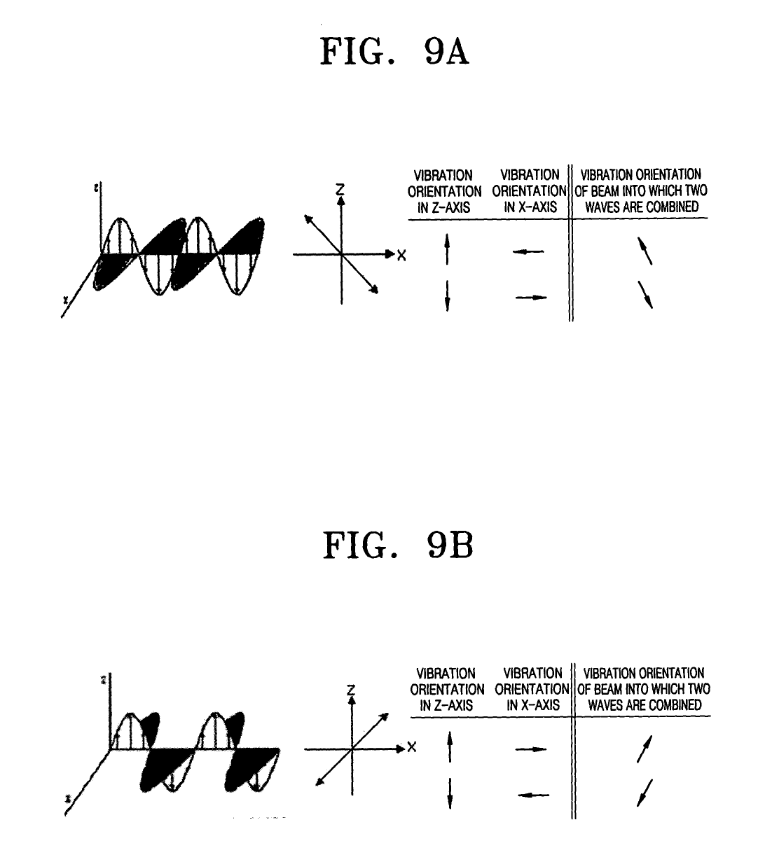

Each of FIGS. 9A and 9B shows the relationship between vibration orientations of two polarized orthogonal beams and a polarization orientation of a beam into which the two polarized orthogonal beams are combined. Natural light is white light with all polarization components, while special equipment such as a laser generator outputs linearly polarized light. As shown in FIG. 9A, when two standard waves proceed in y-axis, vibrating in x-axis and z-axis, respectively, light is polarized at an angle of 45° to the left of z-axis. As can be seen in FIG. 9B, when two standard waves proceed in y-axis, vibrating in x-axis and z-axis, respectively, light is polarized at an angle of 45° to the right of z-axis. Here, the light shown in FIG. 9A is π out of phase with the light shown in 9B with respect to x-axis. In other words, as phases of two beams are controlled, the two beams may vibrate in the right or left orientation and up or down with respect to two orthogonal axes. Accordingly, combinable pairs of vibration orientations of two beams may be (left, up), (right, down), (right, up), and (left, down). Here, as can be seen in FIGS. 9A and 9B, the polarization orientation of a beam into which the two beams are combined is equal to the sum of vectors of vibration orientations of the two beams.

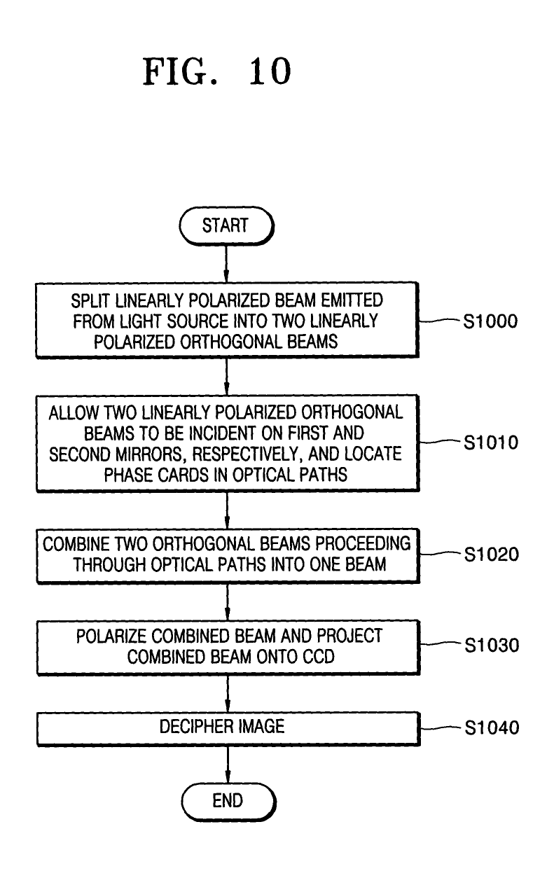

FIG. 10 is a flowchart of a method of deciphering an image according to the present invention. Referring to FIG. 10, in step S1000, the PBS 820 splits a linearly polarized beam emitted from the light source 810 into two linearly polarized orthogonal beams. In step S1010, the two linearly polarized orthogonal beams are incident on the first and second mirrors 830 and 840, respectively, and the phase cards 890-1 and 890-2 are located in optical paths between the first mirror 830 and the BS 850 and between the PBS 820 and the second mirror 840, respectively. In step S1020, the BS 850 combines the two linearly polarized orthogonal beams, which have been reflected from the first and second mirrors 830 and 840 and have passed through the phase cards 8901 and 890-2, into one polarized beam. In step S1030, the polarizer 860 receives the one polarized beam, transmits only a one-orientation-polarized beam, and projects the one-orientation-polarized beam onto the CCD 870. In step S1040, the CCD 870 outputs the projected beam to the image display device 880.

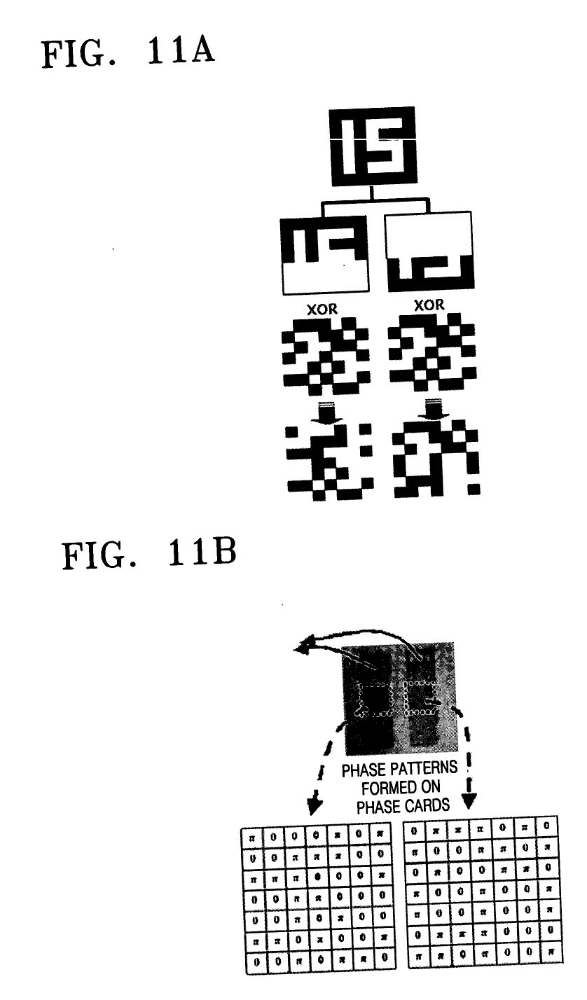

FIGS. 11A and 11B show images and phase cards produced when cryptographing an image using the image cryptographing method of the present invention.

Referring to FIG. 11A, since a number of segmented images was set to 2, a number of random images for cryptograph was m−1. Thus, one random image was generated. An XOR operation was performed on the one random image and each of two segmented images to produce cryptographed images corresponding to the two segmented images.

FIG. 11B shows phase cards corresponding to the cryptographed images shown in FIG. 11A. ITO glass was used as a medium of the phase cards, and the thicknesses of the phase cards varying depending on pixel values were calculated using Equation 1. For the calculation of the thicknesses, A was set to 632.8 nm, n was set to 1.52 which is the standard refractive index of the ITO glass, φ was se to π for pixel values of 0 but 5 π for pixel values of π. As can be seen in FIG. 11B, phase patterns carved in the ITO glass cannot be deciphered by the human visual system or general recording devices such as CCD cameras or the like. Thus, although phase cards are illegally obtained, it is quite difficult to copy the patterns of the phase cards.

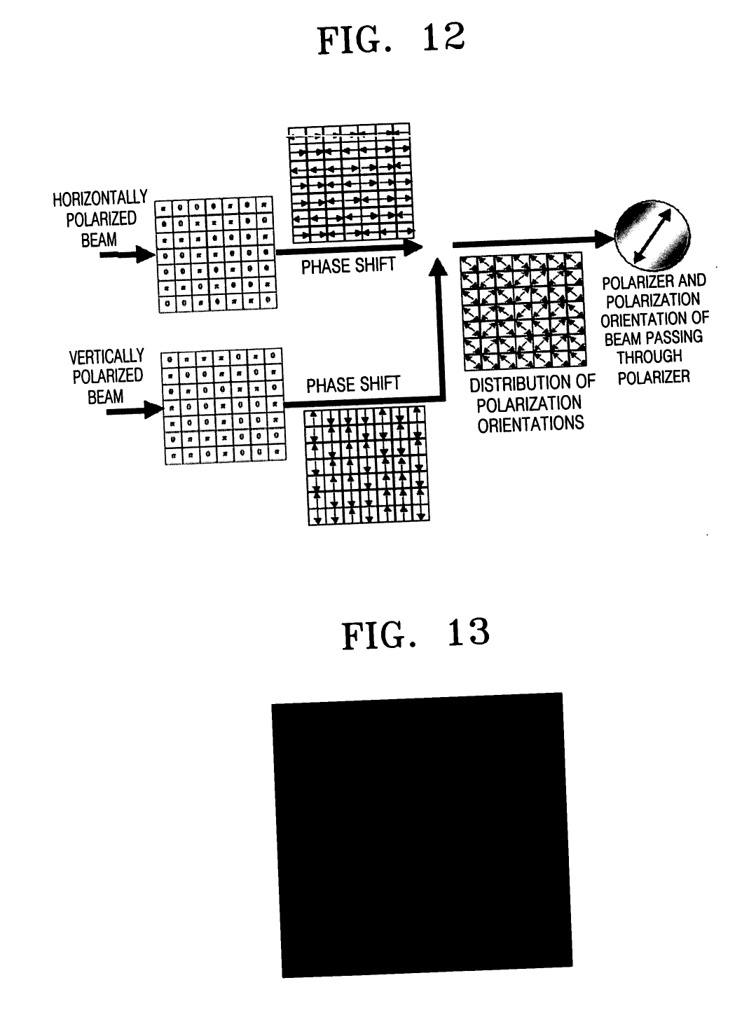

FIG. 12 shows vibration orientations of two beams passing through the phase cards of FIG. 11B located in different interferential paths of the image deciphering apparatus of the present invention and a polarization orientation of a beam into which the two beams are combined. FIG. 13 shows an image obtained by recording light, which passed through a polarizer as shown in FIG. 2, using a CCD.

As described above, according to an apparatus and method for cryptographing and/or deciphering an image, an intrusion into a global network can be detected and followed by modifying an edge router and an intrusion detection system in a local network not an existing Internet service provider (ISP). In addition, compared to the conventional apparatus, the apparatus can undergo a minimum modification so as to be adopted in an already-built network. Moreover, minute phase disturbance, which results from vibration of air or the like occurring during propagation of light, can be removed by a polarizer film. As a result, an image can be deciphered without being affected by noise.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for cryptographing an image, comprising:
an image segmenting unit that segments an input binary image into images;
a random image generating unit that generates as many random images as the segmented images;
a cryptographing unit that performs XOR operations on the segmented images and the random images on a one-to-one basis to produce as many cryptographed images as the segmented images; and
a phase card generating unit that assigns phase values of π and 0 to black and white pixels of the cryptographed images to generate phase cards corresponding to the cryptographed images.

2. The apparatus of claim 1, wherein the random image generating unit comprises:
a first random image generating unit that generates first random images 1 less than the number of segmented images; and
a second random image generating unit that performs XOR operations on the first random images to generate a second random image.

3. The apparatus of claim 1, wherein the phase card generating unit etches a transparent medium covered with an etchant to thicknesses corresponding to the phase values assigned to the black and white pixels of the cryptographed images to generate the phase cards.

4. The apparatus of claim 3, wherein the phase card generating unit determines the thicknesses of the phase cards using Equations below:
$$D = \frac{λφ}{2 π ( n - 1 )}$$
wherein λ denotes a wavelength of light transmitting through the phase cards, φ denotes a phase value to be expressed, and n denotes a refractive index of the transparent medium of which the phase cards are made.

5. A method of cryptographing an image, comprising:
segmenting an input binary image into images;
generating as many random images as the segmented images;
performing XOR operations on the segmented images and the random images on a one-to-one basis to produce as many cryptographed images as the segmented images; and
assigning phase values of π and 0 to black and white pixels of the cryptographed images to generate phase cards corresponding to the cryptographed images.

6. The method of claim 5, wherein the generation of the random images comprises:
generating first random images 1 less than the number of segmented images; and
performing XOR operations on the first random images to generate a second random image.

7. The method of claim 5, wherein the generation of the phase cards comprises:
etching a transparent medium covered with an etchant to thicknesses corresponding to the phase values assigned to the black and white pixels of the cryptographed images to generate the phase cards.

8. The method of claim 7, wherein in the generation of the phase cards, the thicknesses of the phase cards are determined using Equations below:
$$D = \frac{λφ}{2 π ( n - 1 )}$$
wherein λ denotes a wavelength of light transmitting through the phase cards, φ denotes a phase value to be expressed, and n denotes a refractive index of the transparent medium of which the phase cards are made.

9. An apparatus for deciphering an image, comprising:
a light source that outputs a linearly polarized beam with a short wavelength;
a polarized beam splitter that splits the linearly polarized beam into two linearly polarized orthogonal beams;
a first mirror that reflects a vertically polarized beam emitted from the polarized beam splitter through a first optical path;
a second mirror that reflects a horizontally polarized beam emitted from the polarized beam splitter through a second optical path;
a beam splitter that combines the vertically and horizontally polarized beams reflected from the first and second mirrors into a beam with a new polarization orientation; and
a polarizer that transmits only a one-orientation-polarized beam of the combined beam so as to decipher the image,
wherein phase cards are generated by assigning phase values of π and 0 to black and white pixels of cryptographed images so as to be respectively located in optical paths between the first mirror and the beam splitter and between the polarized beam splitter and the second mirror.

10. A method of deciphering an image, comprising:
splitting a linearly polarized beam with a short wavelength emitted from a light source into two linearly polarized orthogonal beams;
transmitting the two linearly polarized orthogonal beams through phase cards that are generated by assigning phase values of π and 0 to black and white pixels of cryptographed images and located in optical paths through which the two linearly polarized orthogonal beams pass;
combining the two linearly polarized orthogonal beams, which have passed through the phase cards, into one polarized beam with a new polarization orientation; and
transmitting only a one-orientation-polarized beam of the combined polarized beam so as to decipher the image.
